(19) United States
(12) Patent Application Publication
(10) Pub. No.: US 2016/0349755 A1
(43) Pub. Date: Dec. 1, 2016

(54) VEHICLE CONTROL SYSTEM

(71) Applicant: TOYOTA JIDOSHA KABUSHIKI KAISHA, Toyota-shi (JP)

(72) Inventors: Seiji KUWAHARA, Susono-shi (JP); Kazumi HOSHIYA, Gotemba-shi (JP); Norimi ASAHARA, Numazu-shi (JP); Yoshio ITO, Susono-shi (JP); Takahito ENDO, Nagaizumi-cho (JP); Tadashi FUJIYOSHI, Susono-shi (JP)

(73) Assignee: TOYOTA JIDOSHA KABUSHIKI KAISHA, Toyota-shi (JP)

(21) Appl. No.: 15/138,423

(22) Filed: Apr. 26, 2016

(30) Foreign Application Priority Data
May 25, 2015 (JP) 2015-105156

(51) Int. Cl. G05D 1/02; B62D 15/02; B62D 13/00; B60W 40/13

(52) U.S. Cl. CPC G05D 1/0223; B60W 40/13; B62D 15/025; B62D 13/00

(57) ABSTRACT

A vehicle control system configured to ensure running stability of a vehicle even if a vehicle weight is heavy is provided. The vehicle control system determines a travel locus of the vehicle within a planned route. If the vehicle tows another vehicle, or if a weight of the vehicle is heavier than a predetermined threshold value, the control system alters the travel locus of the vehicle in such a manner that a turning radius of the vehicle is increased.

### CROSS REFERENCE TO RELATED APPLICATIONS

The present invention claims the benefit of priority to Japanese Patent Application No. 2015-105156 filed on May 25, 2015 with the Japanese Patent Office, the entire contents of which are incorporated herein by reference in its entirety.

### BACKGROUND

Field of the Invention

Embodiments of the present application relates to the art of a vehicle control system configured to autonomously control at least a steering angle of a vehicle without requiring a manual operation of a steering wheel.

Discussion of the Related Art

JP-A-2009-166623 describes a device and a method for creating a travel track, and the device is configured to control a driving force, a braking force and a steering angle of the vehicle autonomously based on a planned travel track. According to the teachings of JP-A-2009-166623, the travel track is created in such a manner as to allow a certain slip of tires in a specific zone so that the vehicle is allowed to travel on a slippery road without decelerating the vehicle excessively.

WO2013/108401 describes an engine starting system for a hybrid vehicle having an engine and a motor that is used not only to start the engine but also to generate a driving force. According to the teachings of WO2013/108401, an increasing amount of an output torque of the motor to start the engine is reduced when towing another vehicle in comparison with that during normal running. In addition, during towing another vehicle, a transmission is controlled in such a manner that a downshifting is prevented while inducing a downshifting, or an opening degree of a throttle valve with respect to a depression on an accelerator pedal is increased

JP-A-H11-051169 describes a shift control system for a vehicle having a main transmission adapted to shift a gear stage among first stage to fifth stage, and a sub-transmission adapted to shift a gear stage between two stages. According to the teachings of JP-A-H11-051169, the gear stage of the sub-transmission is shifted to a lower stage to increase a speed ratio during towing another vehicle, and to a higher stage during normal running to decrease the speed ratio.

Conventional autonomous control system for operating a vehicle without requiring manual operations are configured to control a driving force, a braking force and a steering angle based on specifications of the vehicle such as a vehicle weight, a wheelbase etc., and detection values of various kinds of running conditions. That is, if the vehicle tows another vehicle, or if a loading weight of the vehicle is heavier than a predetermined load, a desired acceleration of the vehicle may not be achieved and the vehicle may not be allowed to travel in line with a travel plan by merely controlling the driving force etc. based on the preinstalled data about the vehicle such as the vehicle weight etc. Consequently, a running stability of the vehicle may be worsened.

### SUMMARY

Aspects of embodiments of the present application have been conceived noting the foregoing technical problems, and it is therefore an object of the present application is to provide a vehicle control system configured to improve a running stability of a vehicle especially during turning even if the vehicle tows another vehicle or a loading weight of the vehicle is heavy.

The vehicle control system according to the preferred embodiment of the present application is configured to create a planned route of a vehicle, and to propel the vehicle along the planned route without requiring at least a manual steering operation. In order to achieve the above-explained objective, according to the preferred embodiment of the present application, the vehicle control system is provided with a controller that determines a travel locus of the vehicle within the planned route. Specifically, the controller is configured to alter the travel locus in such a manner that a turning radius of the vehicle is increased if the vehicle tows another vehicle or if a weight of the vehicle is heavier than a predetermined threshold value, in comparison with that of a case in which the vehicle does not tow another vehicle or in which the weight of the vehicle is lighter than the threshold value.

Thus, according to the preferred embodiment of the present application, the controller that creates a travel plan of the vehicle adjusts the travel locus of the vehicle during turning in such a manner as to increase the turning radius of the vehicle, if the vehicle weight is heavier than the predetermined weight, e.g., when towing another vehicle or the like. According to the preferred embodiment, therefore, a lateral acceleration of the vehicle acting on the vehicle during turning can be decreased to ensure running stability of the vehicle during turning.

### BRIEF DESCRIPTION OF THE DRAWINGS

Features, aspects, and advantages of exemplary embodiments of the present invention will become better understood with reference to the following description and accompanying drawings, which should not limit the invention in any way.

FIG. 1 is a flowchart showing a control example carried out by the control system;

FIG. 2 is a schematic illustration showing a travel locus of the vehicle towing another vehicle or carrying a heavy load during turning; and

FIG. 3 is a schematic illustration showing the vehicle to which the control system according to the preferred embodiment is applied.

### DETAILED DESCRIPTION OF THE PREFERRED EMBODIMENT(S)

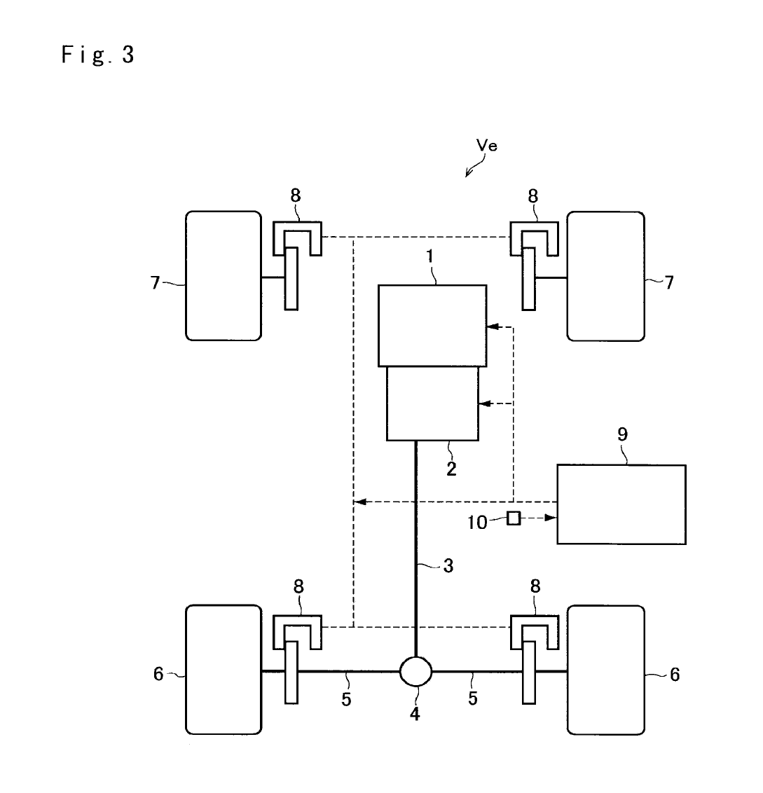

Preferred embodiment of the present application will now be explained with reference to the accompanying drawings. Referring now to FIG. 3, there is shown an example of a front-engine, rear-drive layout vehicle Ve to which the control system according to the preferred embodiment is applied. As illustrated in FIG. 3, the vehicle Ve comprises an engine 1, a transmission 2 connected to the engine 1, and drive wheels 6 connected to the transmission 2 through a propeller shaft 3, a differential gear unit 4 and a driveshaft 5. In the vehicle illustrated in FIG. 3, front wheels 7 are turned to change an orientation of the vehicle, and the front wheels 7 and the drive wheels 6 are individually provided with a brake device 8.

An operating mode of the vehicle Ve can be selected manually by the driver from a manual mode and an autonomous mode. In the manual mode, specifically, a driving force, a braking force and a steering angle of the vehicle Ve are changed by manual operations of an accelerator, a brake device, and a steering wheel. By contrast, in the autonomous mode, the driving force, the braking force and the steering angle of the vehicle Ve are controlled autonomously based on specifications of the vehicle Ve and detection values of running conditions.

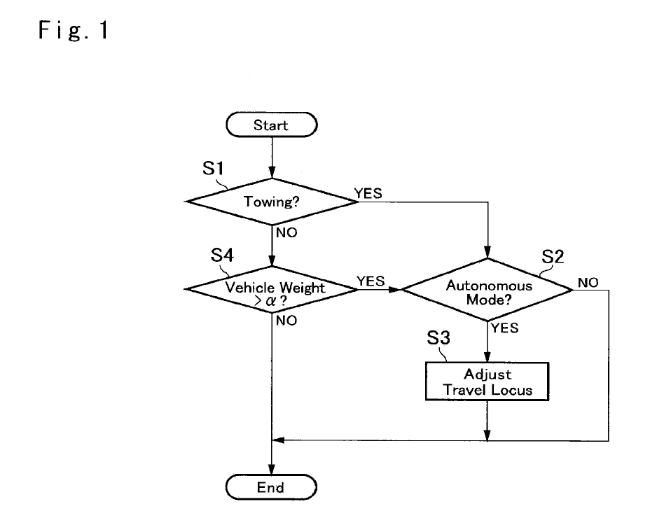

The vehicle Ve is provided with an electronic control unit (to be abbreviated as the “ECU” hereinafter) 9 as a controller composed mainly of a microcomputer. According to the preferred embodiment, the ECU 9 is configured to create a travel plan of the vehicle Ve, and to autonomously control the driving force, the braking force and the steering angle of the vehicle Ve depending on the selected operating mode. To this end, detection signals and information from a various kinds of sensors 10 are sent to the ECU 9. Although only one ECU 9 is depicted in FIG. 1, a plurality of ECUs 9 may be arranged in the vehicle Ve to control each device individually.

Specifically, the sensor 10 includes a weight sensor for detecting a weight of the vehicle Ve, an accelerator sensor for detecting an opening degree of an accelerator, a brake sensor (or switch) for detecting a depression of a brake pedal, a steering sensor for detecting a steering angle of the steering device, an engine speed sensor for detecting a speed of the engine 1, an output torque sensor for detecting an output torque of the vehicle Ve, an output speed sensor for detecting a speed of an output shaft of the transmission 2, a vehicle speed sensor for detecting rotational speeds of the front wheels 8 and the rear wheels 6, a longitudinal acceleration sensor for detecting a longitudinal acceleration of the vehicle Ve, a lateral acceleration sensor for detecting a lateral acceleration of the vehicle Ve, a yaw rate sensor for detecting a yaw rate of the vehicle Ve and so on.

In addition, the sensor 10 further includes at least one of the following external sensors for detecting an external condition, such as an on-board camera, a RADAR (i.e., a radio detection and ranging) a LIDAR (i.e., a laser imaging detection and ranging).

Specifically, the on-board camera is arranged inside of a windshield glass, and transmits recorded information about the external condition to the ECU 9. To this end, not only a monocular camera but also a stereo camera having a plurality of lenses and image sensors to achieve a binocular vision may be used as the on-board camera. If the stereo camera is used as the on-board camera, the ECU 9 is allowed to obtain three-dimensional information in the forward direction.

The RADAR is adapted to detect obstacles utilizing radio waves such as millimetric-waves and microwaves, and to transmit detected information to the ECU 9. Specifically, the RADAR detects an obstacle such as other vehicle and so on by emitting radio waves and analyzing the radio waves reflected from the obstacle.

Likewise, the LIDAR is adapted to detect obstacles utilizing laser light and to transmit detected information to the ECU 9. Specifically, the LIDAR detects an obstacle such as other vehicles and so on by emitting laser light and analyzing the laser light reflected from the obstacle.

In addition, the vehicle Ve is further provided with a GPS (i.e., global positioning system) receiver, a digital map database, and a navigation system. Specifically, the GPS receiver is adapted to obtain a position (i.e., latitude and longitude of the vehicle Ve) based on incident signals from GPS satellites, and to transmit the positional information to the ECU 9. The digital map database may be installed in the ECU 9, but map information stored in external online information processing systems may also be available. The navigation system is configured to determine a travelling route of the vehicle Ve based on the positional information obtained by the GPS receiver and the map database.

The ECU 9 carries out calculations based on the incident data or information from the sensors 10 and preinstalled data, and calculation results are sent in the form of command signal to the engine 1 and the transmission 2, and to the actuators of the brake device 8, the steering device and so on.

In order to operate the vehicle Ve autonomously, the vehicle Ve is provided with a throttle actuator, a brake actuator, a steering actuator and so on. Specifically, the throttle actuator is adapted to change an opening degree of the throttle valve in response to the command signal from the ECU 9. The brake actuator is adapted to actuate the brake device 8 to control braking force applied to the wheels 6 and 7 in response to the command signal from the ECU 9. The steering actuator is adapted to activate the assist motor of the power steering device to control a steering torque in response to the command signal from the ECU 9.

The ECU 9 comprises a position recognizer, an external condition recognizer, a running condition recognizer, a travel plan creator, and a travel controller.

Specifically, the position recognizer is configured to recognize a current position of the vehicle Ve on the map based on the positional information received by the GPS receiver and the map database. The current position of the vehicle Ve may also be obtained from the positional information used in the navigation system. Optionally, the vehicle Ve may also be adapted to communicate with external sensors arranged along the road to obtain the current position of the vehicle Ve.

The external condition recognizer is configured to recognize external condition of the vehicle Ve such as a location of a traffic lane, a road width, a road configuration, a road gradient, an existence of obstacles around the vehicle Ve and so on, based on the recorded information of the on-board camera, or detection data of the RADAR or the LIDAR. Optionally, weather information, a friction coefficient of road surface etc. may be obtained according to need.

The running condition recognizer is configured to recognize running condition of the vehicle Ve such as a vehicle speed, a longitudinal acceleration, a lateral acceleration, a yaw rate and so on based on detection result of the internal sensors.

The travel plan creator is configured to create a travel locus of the vehicle Ve based on a target course determined by the navigation system, a position of the vehicle Ve recognized by the position recognizer, and an external condition recognized by the external condition recognizer. Specifically, the target course as a planned route from a current position of the vehicle Ve is determined by inputting a final destination to the navigation system, and the travel plan creator creates a travel locus of the vehicle Ve within the target course in such a manner that the vehicle Ve is allowed to travel safely and properly while complying traffic rules.

In addition, the travel plan creator is further configured to create a travel plan in line with the created travel locus. The travel plan creator creates a travel plan in line with the target course based on the recognized external conditions and the map database.

Specifically, the travel plan is created based on prospective data after few seconds from the present moment to determine a future condition of the vehicle Ve such as a driving force or the like required in future. Optionally, the travel plan may also be created based on prospective data after several ten seconds depending on the external conditions and the running conditions. Thus, the travel plan creator creates the future plan to change a vehicle speed, acceleration, steering torque etc. during travelling along the target course in the form of e.g., a map.

Alternatively, the travel plan creator may also create a pattern to change the vehicle speed, acceleration, steering torque etc. between predetermined points on the travel locus. Specifically, such patterns may be determined by setting target values of those parameters at each point on the travel locus taking account of a required time to reach the point at the current speed.

The travel controller is configured to operate the vehicle Ve autonomously in line with the travel plan created by the travel plan creator. To this end, specifically, the travel controller transmits command signals to the throttle actuator, the brake actuator, the steering actuator, the shifting actuator and so on in accordance with the travel plan.

The ECU 9 is further configured to control the above-mentioned actuators in response to manual operations of the accelerator, the brake device, and the steering wheel if the manual mode is selected by the driver.

If a loading weight of the vehicle is heavy, for example, if the vehicle Ve tows another vehicle, a boat or the like, the vehicle Ve may be subjected to an excessive centrifugal force during turning. In this case, therefore, a running stability of the vehicle Ve may be decreased if the driving force, the braking force, and the steering angle are still controlled based on the preinstalled data in the autonomous mode. In order to avoid such disadvantage, ECU 9 is further configured to adjust the travel locus of the vehicle Ve created by the travel plan creator depending on a weight of vehicle Ve during propulsion in the autonomous mode, and an example of such control is shown in FIG. 1.

In the routine shown in FIG. 1, it is determined at step S1 whether or not the vehicle Ve is towing another vehicle. Specifically, such determination may be made based on a signal from a towing switch (not shown) that is turned on by the driver when towing another vehicle, or a signal from a towing sensor that detects a fact that the vehicle Ve tows another vehicle. Alternatively, the determination at step S1 may also be made based on a signal from a switch (not shown) arranged at a connection between the vehicle Ve and another vehicle being towed.

If the vehicle Ve is currently towing another vehicle so that the answer of step S1 is YES, the routine progresses to step S2 to determine whether or not the vehicle Ve is currently propelled in the autonomous mode. Specifically, such determination of the current operating mode can be made based on a signal from the switch for selecting the operating mode, or based on a flag representing the autonomous mode.

If the vehicle Ve is currently operated manually in the manual mode so that the answer of step S2 is NO, it is not necessary to alter the travel locus of the vehicle Ve automatically and hence the routine is terminated without carrying out any specific controls. By contrast, if the vehicle Ve is currently operated in the autonomous mode so that the answer of step S2 is YES, the routine progresses to step S3 to adjust the travel locus of the vehicle Ve in such a manner that a lateral acceleration (or a lateral force) of the vehicle Ve is reduced. In other words, the travel locus of the vehicle Ve is altered in such a manner that a turning radius of the vehicle Ve is increased in comparison with that of a case in which the vehicle Ve is not towing another vehicle. Optionally, the vehicle speed may be reduced to reduce a longitudinal acceleration of the vehicle Ve in the event of altering the travel locus.

If the vehicle Ve is currently not towing another vehicle so that the answer of step S1 is NO, the routine progresses to step S4 to compare the detected vehicle weight with a predetermined threshold value a. To this end, the threshold a is set to a level at which the centrifugal force acting on the vehicle Ve during turning is increased to decrease the running stability of the vehicle Ve, if the vehicle weight is heavier than the threshold a. Specifically, the vehicle weight includes a weight of the vehicle Ve itself, a total weight of passengers and a total weight of loads carried by the vehicle Ve. For example, such vehicle weight can be calculated based on: a difference between a theoretical longitudinal acceleration calculated based on an output torque and an actual longitudinal acceleration; and a road gradient. Alternatively, the vehicle weight may also be detected by detecting a depression of a suspension by a suspension sensor (not shown). Optionally, the threshold a may be altered depending on the vehicle speed.

If the vehicle weight is lighter than the threshold a so that the answer of step S4 is NO, the routine is terminated without carrying out any specific controls. By contrast, if the vehicle weight is heavier than the threshold a so that the answer of step S4 is YES, the routine also progresses to step S2. That is, if the weight of the vehicle Ve being operated in the autonomous mode is heavier than the threshold a, the travel locus created by the travel plan creator is also adjusted in such a manner as to reduce the lateral acceleration during turning.

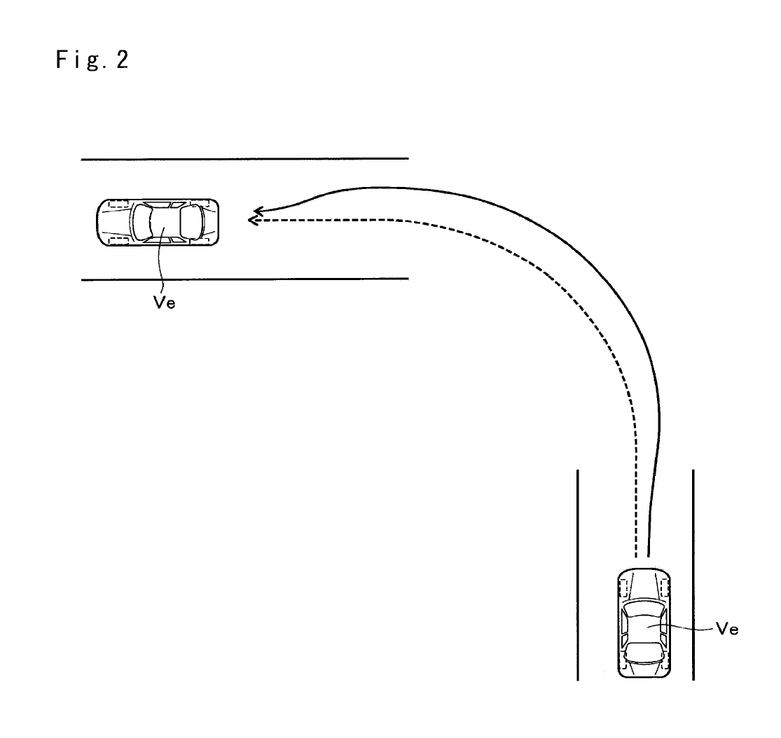

Turning to FIG. 2, there is shown the travel locus altered by the foregoing procedures. In FIG. 2, specifically, the travel locus determined by the travel plan creator is indicated by the dashed line, and the travel locus altered at step S3 is indicated by the solid line. As indicated by the solid line in FIG. 2, the travel locus determined by the travel plan creator is altered in such a manner as to increase the turning radius of the vehicle Ve if the weight of the vehicle Ve propelled in the autonomous mode is heavier than the threshold a. Consequently, the lateral acceleration acting on the vehicle Ve is decreased to ensure the turning stability of the vehicle Ve. In this situation, the lateral acceleration acting on the vehicle Ve can be further decreased by reducing the vehicle speed during turning.

Although the above exemplary embodiments of the present application have been described, it will be understood by those skilled in the art that the present application should not be limited to the described exemplary embodiments, and various changes and modifications can be made within the spirit and scope of the present application. For example, the control system according to the preferred embodiment may also be applied to an autonomous vehicle in which the manual operation mode is not available. In addition, the travel locus may also be altered in such a manner as to adjust the turning radius depending on the vehicle weight.

What is claimed is:

1. A vehicle control system that is configured to create a planned route of a vehicle, and to propel the vehicle along the planned route without requiring at least a manual steering operation, comprising:
a controller that determines a travel locus of the vehicle within the planned route; and
wherein the controller is configured to alter the travel locus in such a manner that a turning radius of the vehicle is increased if the vehicle tows another vehicle in comparison with that of a case in which the vehicle does not tow another vehicle.

2. The vehicle control system as claimed in claim 1, further comprising:
a sensor that detects a fact that the vehicle tows another vehicle; and
wherein the controller is further configured to alter the travel locus in such a manner that the turning radius of the vehicle is increased if the controller receives a signal representing a fact that the vehicle tows another vehicle, in comparison with that of a case in which the vehicle does not tow another vehicle.

3. A vehicle control system that is configured to create a planned route of a vehicle, and to propel the vehicle along the planned route without requiring at least a manual steering operation, comprising:
a controller that determines a travel locus of the vehicle within the planned route; and
wherein the controller is configured to alter the travel locus in such a manner that a turning radius of the vehicle is increased if a weight of the vehicle is heavier than a predetermined threshold value, in comparison with that of a case in which the weight of the vehicle is lighter than the threshold value.

4. The vehicle control system as claimed in claim 3, further comprising:
a sensor that detects the weight of the vehicle; and
wherein the controller is further configured to calculate the weight of the vehicle based on a detection signal from the sensor.

5. The vehicle control system as claimed in claim 4,
wherein the sensor includes a suspension sensor that detects a depression of a suspension, and
wherein the controller is further configured to detect the weight of the vehicle based on the depression of the suspension detected by the suspension sensor.

6. The vehicle control system as claimed in claim 3, further comprising:
an acceleration sensor that detects acceleration of the vehicle; and
a torque sensor that detects an output torque of the vehicle; and
wherein the controller is further configured to calculate acceleration of the vehicle based on specifications of the vehicle and the output torque of the vehicle detected by the torque sensor, and to calculate the weight of the vehicle based on a difference between the calculated acceleration and the acceleration detected by the acceleration sensor.

7. The vehicle control system as claimed in claim 1, further comprising:
a steering actuator that changes a steering angle of the vehicle; and
wherein the controller is further configured to send a signal to the actuator based on the determined travel locus.

8. The vehicle control system as claimed in claim 1, further comprising:
a throttle actuator that changes at least any one of speed and acceleration of the vehicle; and
wherein the controller is further configured to send a signal to the throttle actuator to decrease one of the speed and the acceleration of the vehicle during propelling the vehicle along the determined travel locus.

9. The vehicle control system as claimed in claim 3, further comprising:
a steering actuator that changes a steering angle of the vehicle; and
wherein the controller is further configured to send a signal to the actuator based on the determined travel locus.

10. The vehicle control system as claimed in claim 3, further comprising:
a throttle actuator that changes at least any one of speed and acceleration of the vehicle; and
wherein the controller is further configured to send a signal to the throttle actuator to decrease one of the speed and the acceleration of the vehicle during propelling the vehicle along the determined travel locus.
